(19) United States
(12) Patent Application Publication
(10) Pub. No.: US 2020/0076929 A1
(43) Pub. Date: Mar. 5, 2020

(54) METHOD FOR TRANSMITTING INFORMATION

(71) Applicant: DIEHL METERING SYSTEMS GMBH, NUERNBERG (DE)

(72) Inventors: HRISTO PETKOV, NUERNBERG (DE); THOMAS KAUPPERT, NUERNBERG (DE)

(21) Appl. No.: 16/675,280

(22) Filed: Nov. 6, 2019

Related U.S. Application Data
(63) Continuation of application No. PCT/EP2018/000243, filed on May 7, 2018.

(30) Foreign Application Priority Data
May 30, 2017 (DE) 102017005131.3

(51) Int. Cl. H04L 29/06; H04L 1/08; H04L 1/00; H04Q 9/00

(52) U.S. Cl. CPC H04L 69/22; H04L 1/08; H04Q 2209/60; H04L 1/0061; H04Q 9/00; H04L 69/18

(57) ABSTRACT

A method transmits information, in particular consumption data and/or useful data, in the form of a data packet. The data packet is transmitted repeatedly, preferably at definable time intervals, via radio from a transmitter to a receiver and then the data packet is divided into data subpackets. An interference state of the data subpackets is established on the receiver side. Specific data subpackets are selected on the basis of the interference state, and the selected data subpackets are combined into a new data packet complementary to the data packet. The data packet is transmitted via both a first communication protocol and a second communication protocol, and the data packet is derived from the received data packets. The data packet has a lower level of interference than a data packet which is received exclusively via a single communication protocol.

### CROSS-REFERENCE TO RELATED APPLICATION

This is a continuation application, under 35 U.S.C. § 120, of copending international application No. PCT/EP2018/000243, filed May 7, 2018, which designated the United States; this application also claims the priority, under 35 U.S.C. § 119, of German patent application DE 10 2017 005 131.3, filed May 30, 2017; the prior applications are herewith incorporated by reference in their entireties.

### BACKGROUND OF THE INVENTION

### Field of the Invention

The present invention relates to a method for transmitting information according to the preamble to the independent claim which can be used, for example, to transmit consumption data and/or useful data from consumption-metering devices to a higher-level data collector.

Intelligent consumption-metering meters, also referred to as smart meters, are consumption-metering devices located in a supply network, e.g. for energy, electricity, gas, water, which indicate actual consumption to the respective connection user and are incorporated into a communication network. Intelligent consumption-metering devices offer the advantage that manual meter readings are no longer required and shorter-term billing can be implemented by the supplier according to actual consumption. Due to shorter-term reading intervals, end customer tariffs can in turn be linked more precisely to changes in trading prices for electricity. Supply networks can also be substantially more effectively utilized.

Intelligent consumption-metering devices are normally assigned in each case to residential, industrial or commercial units. The metering data accruing there can be read in a variety of different ways. Metering data can be read e.g. via the electricity grid (Power Line). However, the incorporation of the consumption-metering devices into a supralocal network is not possible here. Metering data can furthermore be transmitted using radio technology in the form of data packets or messages consisting of a plurality of data packets.

Radio data transmission is performed, for example, in the short range devices (SRD) or industrial, scientific, medical (ISM) frequency range, e.g. 850 MHz-950 MHz, to higher-level data collectors, such as e.g. concentrators, a network node point or the control center of the supplier. The SRD or ISM frequency ranges offer the advantage that they are license-free and only a general approval of the frequency administration is required for use. However, the problem exists that interference can frequently occur due to the frequency of use of frequency ranges of this type for a wide range of technical devices, such as garage door controllers, baby monitors, alarm systems, WLAN, Bluetooth, smoke alarms or the like.

The data packets are normally coded for radio transmission according to a communication protocol. Here, the communication protocol comprises e.g. the frequency range, the communication channel, the signal strength or the like. The communication protocol of the M-bus (“Meter Bus”), for example, can be used as the communication protocol. The M-bus corresponds to a standard or technical standard (EN 13575) which specifies the type and manner of the consumption data transmission from consumption meters within a communication system.

A method for transmitting information from consumption-metering devices is known from international patent disclosure WO 2015/074666. In the method, data packets can be received by different receivers. The data packets are divided here into a first part and a second part. The first part is preferably coded according to the M-bus protocol and comprises the consumption data of the consumption-metering devices. The second part comprises error correction information which serves to carry out an error correction on the first part. The first part can be transmitted in a first communication range independently from the second part. The entire data packet, consisting of the first and second part, can be transmitted within a second, greater communication range, wherein a subsequent error correction is performed on the basis of the error correction information in the second part. Since the error correction information is received only in the second communication range via a correspondingly configured receiver, no error correction can be performed if transmission takes place in the first communication range. Interference can frequently occur precisely in this short transmission range via frequencies from 850 MHz-950 MHz. The susceptibility to interference of the data transmission is correspondingly high. The probability of a successful transmission of a data packet is thereby reduced. Consequently, the data packet must be transmitted more frequently until it has been successfully transmitted, resulting in a high energy requirement.

### SUMMARY OF THE INVENTION

The object of the present invention is to provide a novel method for transmitting information, in particular consumption data and/or useful data, in which the transmission probability and energy efficiency are improved and susceptibility to interference is reduced.

The present object is achieved by the entire teaching of the independent claim. Appropriate designs of the invention are claimed in the subclaims.

With the foregoing and other objects in view there is provided, in accordance with the invention, a method for transmitting information in a form of a data packet. The method includes transmitting the data packet repeatedly via radio from a transmitter to a receiver via both a first communication protocol and a second communication protocol. The data packet is divided into data subpackets. An interference state of the data subpackets is established on a receiver side. Specific data subpackets are selected on a basis of the interference state. The selected data subpackets are combined into a new data packet complementary to the data packet. The new data packet is derived from the data packets received, wherein the new data packet has a lower level of interference than the data packet which is received exclusively via a single communication protocol.

The present invention is based on the notion that every data packet or at least a part of the data packets to be transmitted is transmitted at least once via a first communication protocol and via a second communication protocol. This offers the resulting advantage that interfering influences can be avoided in the data transmission or signal transmission by using two communication protocols for the transmission. A conventional communication protocol, for example, such as e.g. that of the M-bus (“Meter Bus”; EN13757), can be used as the first communication protocol, and a proprietary communication protocol can be used as the second communication protocol. The second communication protocol can thus comprise means, such as e.g. a synchronization sequence, which increase transmission reliability or reduce the susceptibility to interference of the (data) transmission, but which do not form part of the conventional communication protocol. According to the invention, from a multiple transmission of one data packet via the first and the second communication protocol, a data packet is derived or compiled on the receiver side which has a reduced level of interference compared with a data packet received in each case from the transmission repetitions via only a single communication protocol. The transmission probability of the data packet is furthermore improved since a plurality of communication protocols are used for the transmission of the data packet and data subpackets can be combined independently from the respective communication protocol. The number of required data transmissions can thereby be substantially reduced, as a result of which the energy efficiency of the transmitter is improved.

The second communication protocol preferably comprises a “pilot”, particularly in the form of a synchronization sequence, such as e.g. a signal, a preamble and/or postamble, a beacon or the like, and/or additional information, such as e.g. a header, core data, header data, metadata or the like, which are generated, in particular, on the transmitter side, and are assigned to the data packets and/or data subpackets. This offers the resulting advantage that the data packets can be announced, e.g. by a preamble, wherein the transmitters and/or receivers are synchronized, and/or by a postamble, wherein, in the case of an interference-affected preamble, a successful synchronization can nevertheless be performed. In addition, incorrectly transmitted or interference-affected data packets can nevertheless be detected, e.g. by a checksum or an error detection code. This can be performed, in particular, using a three-out-of-six error detection, a cyclic redundancy check (CRC), e.g. for each data packet, or a bit matching of the data packet transmission repetitions. The probability of a successful data transmission is thereby additionally increased.

The synchronization sequence and/or the additional information can appropriately be assigned to the data packets and/or data subpackets in such a way that the synchronization sequence and/or the additional information is/are transmitted before, between and/or after the respective data packet and/or data subpacket.

Definable time intervals can furthermore be provided between the transmitted synchronization sequences of the data packets, wherein the establishment of the interference state of a data packet and/or a data subpacket is derived from the defined time intervals. It can thereby be established whether a data packet and/or a data subpacket has been transmitted (without interference), since the chronological order of the synchronization sequences and preferably also the temporal position of the data packets or data subpackets in relation to the synchronization sequence is known. Furthermore, data subpackets, in particular, occurring without interference, of an overall interference-affected data packet can be used, without the synchronization sequence assigned to these data subpackets or to the corresponding data packet having been received, in order to derive a data packet with a lower level of interference on the receiver side. This can be done by determining the position of the data subpackets received without interference within the data packet by the time intervals between the transmitted synchronization sequences. The respective data subpacket can thereby be identified. This is enabled, for example, due to the knowledge of the time intervals between the synchronization sequence and the respective data packet or data subpacket.

The transmitters and receivers normally comprise a time reference device, e.g. a quartz oscillator, for the temporal alignment of the information transmission. Due to temporal deviations in the time reference devices of the transmitter and receiver, the data subpackets which are disposed temporally closer to a synchronization sequence which affects synchronization are less susceptible to interference, so that different transmission probabilities of the respective data subpackets can occur. This difference can be avoided or at least reduced by modifying the transmission sequence of the data subpackets in the transmission repetitions of the data packet. This can be done, for example, using an algorithm, or pseudo-randomly. However, the transmission sequence is preferably known here at the transmitting end and at the receiving end. This offers the advantage that the data subpackets can be disposed within the transmission repetitions of the data packet in such a way that the data subpackets are disposed in each case in differing proximity to the synchronization sequence, e.g. from transmission repetition to transmission repetition. The probability of an interference-free transmission of all the data subpackets can thereby be improved by increasing the transmission probabilities of the data subpackets as a whole.

A time synchronization of the first and/or second communication protocol is preferably performed in order to compile the data packet. The time synchronization of the first and/or second communication protocol can be performed in each case using a synchronization sequence which has been transmitted via the first and/or the second communication protocol. This offers the resulting advantage, for example, that the time synchronization of the first communication protocol can also be performed using a synchronization sequence transmitted via the second communication protocol. The transmission reliability can thereby be improved to a particular extent.

The first and the second communication protocol can appropriately be transmitted via different transmission systems. In particular, for example, the coding of the information or of the data packets, e.g. source coding, line coding, channel coding or the like, can be modified. This coding must then be decoded once more and, if necessary, amplified and demodulated on the receiver side. The hardware and software of the receivers are preconfigured accordingly in such a way that they support a transmission via different transmission systems.

The data packets can be divided into data subpackets on the receiver side and/or on the transmitter side. The receiver can, for example, divide the received data packets into data subpackets and can establish the interference state of the data subpackets, e.g. via a checksum or a comparison (e.g. bit-by-bit) of a plurality of received data packets. Alternatively, the transmitter divides the data packets into data subpackets, assigns an error correction in each case to the data subpackets, e.g. in the form of a postamble, and transmits them with the assigned data packets or data subpackets to the receiver. The receiver can carry out the error correction of the data packets or data subpackets here following successful reception.

The data packets and/or data subpackets can furthermore be coded in such a way that the receiver can decode the data packets and/or data subpackets individually, i.e. it does not have to receive the entire data packet in order to decode it.

Alternatively or additionally, definable time intervals can also be provided between the data subpackets, particularly if the data packets are divided into data subpackets on the transmitter side. The temporal position of the data subpackets can thereby be determined on the basis of the time intervals between the synchronization sequences and on the basis of the time intervals between the data subpackets. The transmission probability of a data packet is even further improved as a result.

In addition, the information or the data packet and/or the data subpackets can appropriately be transmitted via a third communication protocol and/or via a fourth communication protocol. The transmission reliability and transmission probability can be even further improved as a result.

According to one preferred design of the present invention, the information consists of consumption data and/or useful data, i.e. metering data and/or program data which are provided by consumption-metering devices, particularly by heat, electricity and/or water meters. The consumption-metering devices are normally battery-operated and therefore transmit using battery-saving transmission methods, in particular by radio transmission or short-range radio transmission, e.g. via ISM or SRD bands preferably in the range from 850 to 950 MHz. Transmission reliability can be improved here, susceptibility to interference of the data transmission can be reduced and energy efficiency can ultimately be increased to a particular extent through reduced transmit and receive standby times, so that the present invention also makes an outstanding contribution to the development of the information transmission of consumption-metering devices of this type.

Other features which are considered as characteristic for the invention are set forth in the appended claims.

Although the invention is illustrated and described herein as embodied in a method for transmitting information, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified schematic representation of a communication system containing a plurality of transmitters and one receiver;

FIG. 2 is a simplified schematic representation of one configuration of the method according to the invention;

FIG. 3 is a simplified schematic representation of a message having a plurality of data packets;

FIG. 4 is a simplified schematic representation of a data packet having four data subpackets;

FIG. 5 is a simplified schematic representation of a data packet having a plurality of data subpackets with an assigned preamble and postamble;

FIG. 6 is a simplified schematic representation of three data packets having in each case of a plurality of data subpackets in each case with assigned preambles;

FIG. 7 is a simplified schematic representation of a data packet having a plurality of data subpackets with an assigned preamble and defined time intervals between the preamble and the data subpackets;

FIG. 8 is a simplified schematic representation of three data packets having in each case of a plurality of data subpackets in each case with assigned preambles and a varying transmission sequence of the data subpackets; and

FIG. 9 is a simplified schematic representation of a data packet with a header and an assigned preamble and postamble.

### DETAILED DESCRIPTION OF THE INVENTION

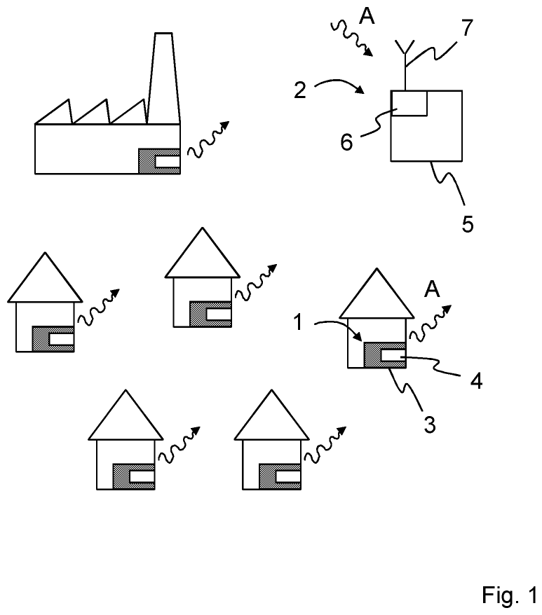

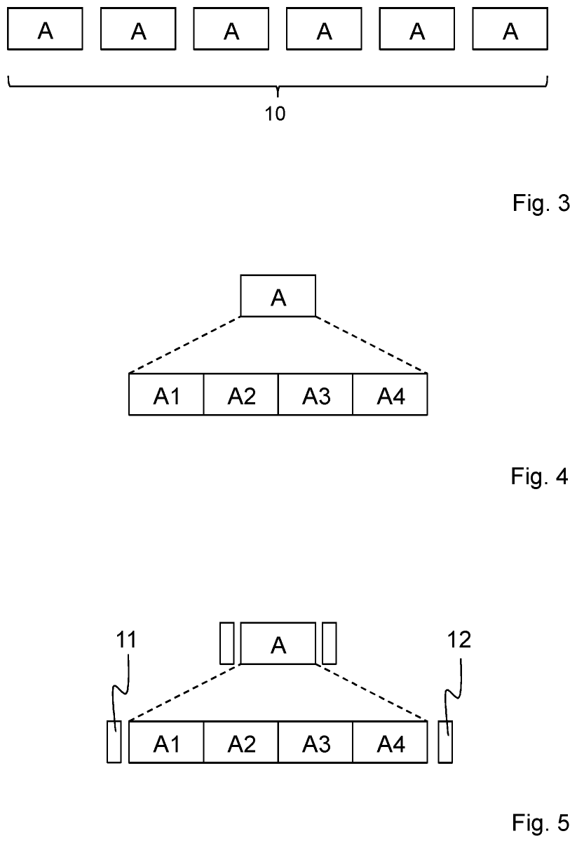

Referring now to the figures of the drawings in detail and first, particularly to FIG. 1 thereof, there is shown a communication system in which a plurality of transmitters 1 transmit information to a receiver 2. The transmitters 1 are consumption-metering devices 3 which are assigned to residential and/or industrial units. The consumption-metering devices 3 contain a communication module 4 or a transceiver unit for transmitting and receiving the information, such as e.g. the present consumption of water or electricity. The consumption-metering device 3 transmits this information via the communication module 4 to the receiver 2. The receiver 2 is a data collector 5 which contains a communication module 6 and an antenna 7 for transmitting and receiving information. The data collector 5 may be a concentrator, the control center of an energy supplier, a mobile reading device for walk-by or drive-by reading or the like. The information is transmitted here in the form of data packets A or, according to FIG. 3, by means of a message 10 composed of a plurality of data packets A, from the transmitters 1 to the receiver 2.

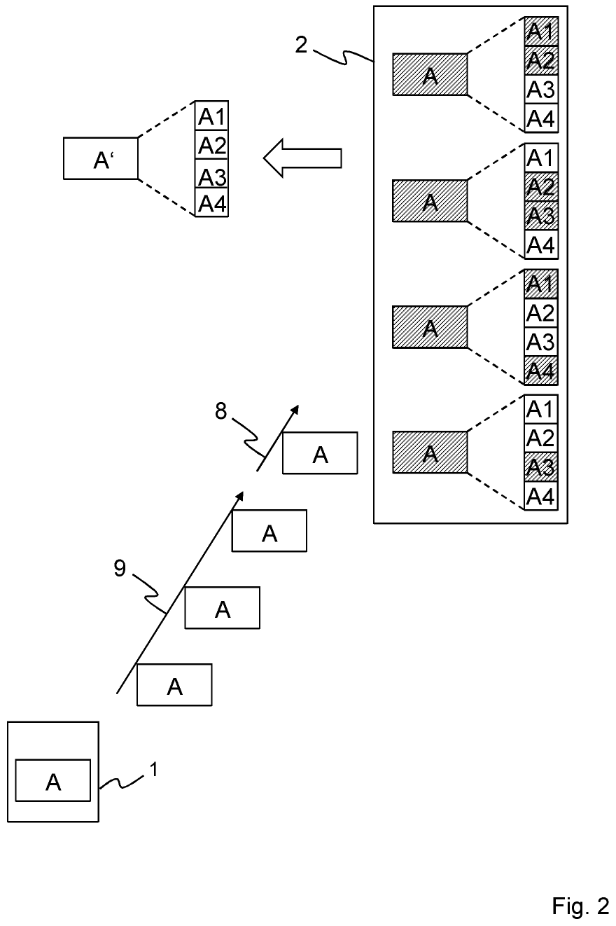

The method according to the invention for transmitting information in the form of data packets A is shown in detail schematically in FIG. 2. The transmitter 1 first generates a data packet A, e.g. from the consumption data. The data packet A is transmitted from the transmitter 1 according to a first communication protocol 8 to the receiver 2. The data packet A can preferably be transmitted via the ISM band frequency ranges and/or the SRD band frequency ranges, particularly in the frequency range from 867 MHz to 873 MHz. The receiver 2 first receives the data packet A which has been transmitted via the first communication protocol 8 to the receiver 2. The receiver 2 is configured here to divide the data packet A according to FIG. 4 into data subpackets A1, A2, A3, A4. The transmitter 1 then transmits the data packet A multiple times, e.g. three times according to FIG. 2, to the receiver 2 via a second communication protocol 9. The data packets A transmitted via the second communication protocol 9 are similarly received by the receiver 2 and are then divided into data subpackets A1, A2, A3, A4. The shading shown in FIG. 2 of the data packets A or the data subpackets A1, A2, A3, A4 received by the receiver 2 indicates interference affecting the received data packets A or the data subpackets A1, A2, A3, A4. The data packets A must normally be discarded due to this interference. Interference of this type in the transmission of the data packets A can be caused e.g. by interference sources such as e.g. by data transmissions of external devices which transmit on the same frequencies, interferences, overlaps or the like.

However, as shown in FIG. 2, the data subpackets A1, A2, A3, A4 of an interference-affected data packet A are not necessarily all affected by interference. The data packets A are first divided on the receiver side into the respective data subpackets A1, A2, A3, A4. The receiver 2 can then establish the interference state of the data subpackets A1, A2, A3, A4. This can be done, for example, by the receiver 2 comparing the data subpackets A1, A2, A3, A4 of all received data packets A with one another, in particular bit-by-bit. The receiver 2 can select the interference-unaffected data subpackets on the basis of the determined interference state of the data subpackets A1, A2, A3, A4 and can combine them into an interference-unaffected data packet A′. This newly assembled data packet A′ has a considerably lower level of interference compared with the data packets A received by the receiver 2.

According to the invention, the receiver 2 is configured to be able to receive and decode the data packets A via a plurality of transmission protocols 8, 9. According to one particular design of the method according to the invention, a third and/or a fourth and/or even further transmission protocols can also be provided for the transmission of the data packets A.

According to FIG. 5, the second communication protocol 9 appropriately contains a synchronization sequence, such as e.g. a preamble 11 and/or a postamble 12. Synchronization sequences of this type serve to announce the transmission of the data packet A to the receiver 2 and, if necessary, to effect a synchronization of the transmitter 1 and the receiver 2. The synchronization sequence is generated on the transmitter side and is assigned to the data subpackets or the data packets. The synchronization sequences can be assigned here in such a way that they are located before, between and/or after the respective data packet A or the data subpackets A1, A2, A3, A4.

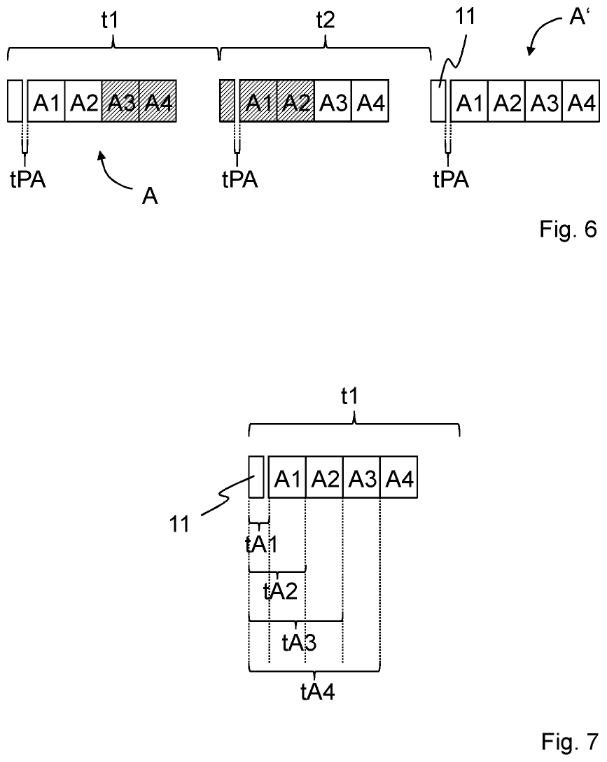

According to one preferred design of the present invention as shown in FIG. 6, time intervals t1, t2 are defined between the transmitted synchronization sequences, e.g. a preamble 11. The establishment of the interference state of a data packet A or a data subpacket A1, A2, A3, A4 can be derived from these defined time intervals t1, t2. This can be done, for example, by using the time gaps tPA between the preamble 11 and the data packet A or the data subpackets A1, A2, A3, A4 to determine the interference-affected data subpacket A1, A2, A3 and/or A4. In particular, the synchronization sequences and/or the data packets A or the data subpackets A1, A2, A3, A4 in FIG. 6 may also have been transmitted via different communication protocols 8, 9.

In addition, as shown in FIG. 7, the time gaps tA1, tA2, tA3, tA4 between the synchronization sequence or the preamble 11 and the data subpackets A1, A2, A3, A4 are also used to establish the interference state of the data packet A and/or the respective data subpackets A1, A2, A3, A4.

It has surprisingly become evident here that synchronization sequences or preambles 11 or postambles 12 affected by interference or not transmitted at all can be compensated by previously and/or subsequently transmitted synchronization sequences if, for example according to FIG. 6, the time interval t1+t2 between the first and the third preamble 11 and therefore the interference of the second preamble 11 can be compensated. Due to the clock deviations of the time reference devices of the transmitters 1 and receivers 2, time deviations, i.e. shifts in the time intervals t1, t2 or the time gaps tA1, tA2, tA3, tA4, can occur, so that the detection of the interference source or the combination of the data subpackets A1, A2, A3, A4 is hindered. The risk of a time deviation of the transmitters 1 and receivers 2 can be reduced by a synchronization of the time reference device, e.g. via the preamble 11 or the postamble 12. The probability of a successful, i.e. interference-unaffected, transmission of a data subpacket A1, A2, A3, A4 of the data packet A is consequently higher, the closer the data subpacket A1, A2, A3, A4 is located to the synchronization sequence.

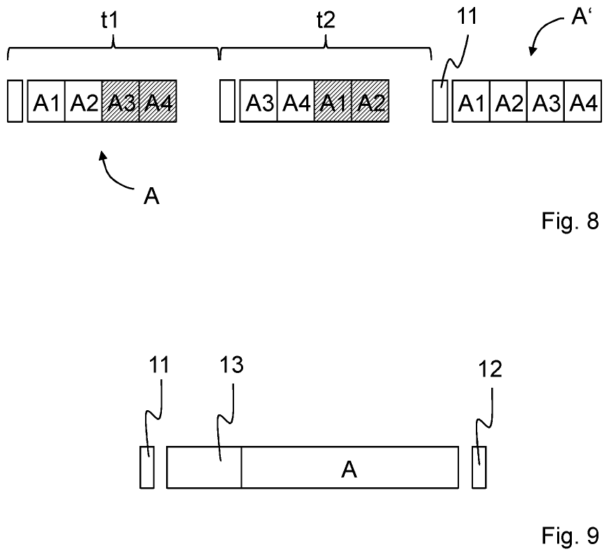

According to FIG. 8, the transmission sequence of the data subpackets A1, A2, A3, A4 can appropriately be modified in the transmission repetitions of the data packet A in such a way that the probability of a successful transmission of each of the data subpackets A1, A2, A3, A4 is essentially equally high. As shown in FIG. 8, an overall interference-unaffected data packet A can therefore be received or assembled through the variation of the transmission sequence even though the data subpackets A3 and A4 or A1 and A2 located further away from the preamble 11 were in each case affected by interference in the first two transmission repetitions. Alternatively or additionally, transmission priorities can also be defined via the positions of the data subpackets by disposing data subpackets A1, A2, A3, A4 with a higher transmission priority preferably close to the synchronization sequence.

The data packets A can preferably be divided into data subpackets A1, A2, A3, A4 on the receiver side and/or on the transmitter side. Either the transmitter 1 already divides the data packets A into data subpackets A1, A2, A3, A4 and transmits them preferably with definable time intervals placed between them to the receiver 2, or the transmitter 1 transmits the data packets A according to FIG. 2 to the receiver 2, wherein the data packets A are divided into data subpackets A1, A2, A3, A4 on the receiver side following reception. The data packets A or the data subpackets A1, A2, A3, A4 are coded here in such a way that the receiver 2 can decode the data packets A or the data subpackets A1, A2, A3, A4 in each case individually.

FIG. 9 shows a data packet A with a preamble 11 and a postamble 12, wherein the data packet A additionally contains prefixed additional information in the form of a header 13. The header 13 can contain core data, metadata or the like which in turn contain e.g. the ID numbers of the transmitter 1 and the receiver 2, the data format, address information, the character encoding or the like.

Individual feature combinations (subcombinations) and possible combinations of individual features of different design forms not shown in the drawing figures are expressly included in the disclosure content.

### REFERENCE NUMBER LIST

1 Transmitter
2 Receiver
3 Consumption-metering device
4 Communication module
5 Data collector
6 Communication module
7 Antenna
8 First communication protocol
9 Second communication protocol
10 Message
11 Preamble
12 Postamble
13 Header
A Data packet
A′ Assembled data packet A
A1 Data subpacket
A2 Data subpacket
A3 Data subpacket
A4 Data subpacket
t1 Time interval (between first and second preamble)
t2 Time interval (between second and third preamble)
tA1 Time gap (between preamble and data subpacket A1)
tA2 Time gap (between preamble and data subpacket A2)
tA3 Time gap (between preamble and data subpacket A3)
tA4 Time gap (between preamble and data subpacket A4)
tPA Time gap (between preamble and data packet)

1. A method for transmitting information in a form of a data packet, which comprises the steps of:
transmitting the data packet repeatedly via radio from a transmitter to a receiver via both a first communication protocol and a second communication protocol;
dividing the data packet into data subpackets;
establishing an interference state of the data subpackets on a receiver side;
selecting specific data subpackets on a basis of the interference state;
combining selected data subpackets into a new data packet complementary to the data packet; and
deriving the new data packet from the data packets received, wherein the new data packet has a lower level of interference than the data packet which is received exclusively via a single communication protocol.

2. The method according to claim 1, wherein the first communication protocol and/or the second communication protocol includes a synchronization sequence and/or additional information which is generated on a transmitter side and is assigned to the data packets and/or the data subpackets.

3. The method according to claim 2, wherein the synchronization sequence and/or the additional information is/are assigned to the data packets and/or the data subpackets in such a way that the synchronization sequence and/or the additional information is/are transmitted before, between and/or after the data packet and/or the data subpackets.

4. The method according to claim 2, which further comprises defining time intervals between transmitted synchronization sequences of data packets and an establishment of the interference state of the data packet and/or a data subpacket is derived from a defined time intervals.

5. The method according to claim 1, which further comprises varying a transmission sequence of the data subpackets in transmission repetitions of the data packet.

6. The method according to claim 1, which further comprises performing a time synchronization of the first communication protocol and/or the second communication protocol in order to compile the new data packet.

7. The method according to claim 1, which further comprises transmitting the first communication protocol and the second communication protocol via different transmission systems.

8. The method according to claim 1, which further comprises dividing the data packets into the data subpackets on the receiver side and/or on a transmitter side.

9. The method according to claim 1, which further comprises coding data packets and/or the data subpackets in such a way that the receiver can decode the data packets and/or the data subpackets individually.

10. The method according to claim 1, wherein definable time intervals are provided between the data subpackets.

11. The method according to claim 1, which further comprises additionally transmitting the data packet via a third communication protocol and/or via a fourth communication protocol.

12. The method according to claim 1, which further comprises providing the information as consumption data and/or useful data in a form of metering data by a consumption-metering device.

13. The method according to claim 1, which further comprises:
selecting the information from the group consisting of consumption data and useful data; and
transmitting the data packet repeatedly at definable time intervals.

14. The method according to claim 12, wherein the consumption-metering device is a heat meter, an electricity meter or a water meter.
